(19) United States
(12) Patent Application Publication
(10) Pub. No.: US 2026/0084897 A1
(43) Pub. Date: Mar. 26, 2026

(54) DEVICE FOR TRANSPORTING SLICES OF FOOD

(71) Applicant: GEA Food Solutions Germany GmbH, Biedenkopf-Wallau (DE)

(72) Inventors: Maximilian Fikentscher, Kempten (DE); Martin Knura, Lorch (DE)

(21) Appl. No.: 19/110,158

(22) PCT Filed: Oct. 10, 2023
(86) PCT No.: PCT/EP2023/078051

§ 371 Date: Mar. 10, 2025

(30) Foreign Application Priority Data
Oct. 10, 2022 (DE) 10 2022 210 676.8

(51) Int. Cl. B65G 15/12; B65G 23/06

(52) U.S. Cl. CPC B65G 15/12; B65G 23/06; B65G 2201/0202; B65G 2207/26

(57) ABSTRACT

An apparatus for transporting food slices having at least two conveyor belts, at least two drive rollers, each of the at least two conveyor belts can be guided about one of the respective at least two drive rollers and can be driven thereby, a moveable frame including a plurality of plug-in axles, each of the plurality of plug-in axles being securely connected to the moveable frame, the moveable frame is moveable between an operating position and a maintenance position, in the operating position, the at least two drive rollers and the plurality of plug-in axles are arranged parallel to one another and each of the at least two drive rollers is arranged laterally between two plug-in axles.

### CROSS REFERENCE TO RELATED APPLICATIONS

This application is a National Stage Entry of PCT/EP2023/078051 filed on Oct. 10, 2023, which claims priority to DE 10 2022 210 676.8 filed on Oct. 10, 2022, the entireties of which are all hereby incorporated by reference herein for all purposes.

### FIELD

The present invention proceeds from an apparatus for transporting food slices having at least two conveyor belts and at least two drive rollers.

### BACKGROUND

Such apparatuses are used in the foods industry in order to transport rod-shaped products such as, for example, sausage or cheese. They may be arranged downstream or upstream of so-called “slicers”, i.e., high-speed cutting devices, for example having up to 1000 cuts per minute, that cut the rod-shaped food products into slices. The food products are transported in a single track, i.e., individually, or in multiple tracks, i.e., parallel to one another, by means of a feed unit to a cutting plane in the region of a cutting element. In the cutting plane the food products are cut into slices using the cutting element, in particular a rotating circular blade or sickle-shaped blade. The slice thickness is determined by the advancing rate of the individual food products. As a rule, the cut slices are arranged and packaged into portions at a constant blade speed and/or by weight.

One current design of such apparatuses disclosed in the prior art provides that the drive rollers have a free end, i.e., are embodied cantilevered and project. Due to the drive rollers being mounted on one side, load distribution is also uneven. In addition, due their rotation property, the drive rollers may represent an operational hazard for bystanders. Moreover and in particular, such apparatuses by their nature and as a result of operating require regular cleaning measures in order to meet the stringent hygiene standards of the foods industry. The high number of cleaning and maintenance periods may be a drawback, because it may be necessary to partially disassemble/change over the apparatus for cleaning purposes and this may result in lower efficiency during production.

### SUMMARY

It is therefore an object of the invention to provide an apparatus for transporting food products that does not have the drawbacks described in connection with the prior art and in particular that permits shorter changeover periods.

The object of the present invention is attained using an apparatus for transporting food slices having:
at least two conveyor belts,
at least two drive rollers, wherein each of the conveyor belts can be guided about one of the respective drive rollers and can be driven thereby,
a movable frame comprising a plurality of plug-in axles, each being securely connected to the frame, wherein the frame is movable between an operating position and a maintenance position, wherein in the operating position the drive rollers and the plurality of plug-in axles are arranged parallel to one another and each of the drive rollers is arranged laterally between two plug-in axles.

Due to the movability of the frame and the simple manner in which it can be removed, the advantage of rapid changeover may be attained in that frames may be exchanged for one another and cleaned. The removal and reinstallation of the frame may be accomplished using movement of the frame in all three spatial directions, in particular a combination of movements in all three spatial directions.

The apparatus has at least two conveyor belts. The number of conveyor belts may be limited to a maximum of six, determined by design and space considerations. There are preferably exactly six conveyor belts. In addition, the apparatus has at least two drive rollers. The number of drive rollers may also be limited to six. Preferably there are exactly six drive rollers. Each of the conveyor belts may be guided about one respective drive roller and driven thereby. The wrap angle of the conveyor belts about a drive axis is preferably about 180°. In addition, a wrap length of the conveyor belts is preferably a maximum of 5% of the total length of a conveyor belt, in particular preferably a maximum of 3%. Conveyor belts that are profiled or smooth-surfaced on one side having corresponding profiled or smooth-surfaced drive rollers are possible. The drive rollers may each have a discrete drive, in particular an electric motor. It is also possible for a common drive to be assigned to a plurality of drive rollers, wherein the drive energy may be distributed, for example, via V belts, to the plurality of drive rollers. In addition, the drives may have a gear stage.

According to the invention, the apparatus has a movable frame that comprises a plurality of plug-in axles, wherein the plug-in axles are securely connected to the frame. The plug-in axles may be connected to the frame using a plug-in, clamping, latching, welded, or other connection. The plug-in axles and the frame may also be embodied in one piece. The frame is movable between an operating position and a maintenance position. In the operating position, the plug-in axles and the drive rollers are arranged parallel to one another. Each conveyor belt may be guided at least partially between a plug-in axle and a drive roller. The plug-in axles are preferably made of a plastic for increasing friction and exert pressure on the conveyor belt in order to tension the conveyor belt, at least partially. In the maintenance position, the frame is moved relative to the operating position so that a distance is formed between the drive rollers and the plug-in axles.

According to one advantageous embodiment of the invention, it is provided that the frame is pivotable between the operating position and the maintenance position, wherein in the maintenance position an angle is formed between the drive rollers and the plug-in axles. The angle is preferably greater than 15°. An angle greater than 20° is particularly preferred. The frame may be removed in the maintenance position.

According to one preferred embodiment of the invention it is provided that a belt body comprising the conveyor belts has a foldable fastening element, wherein in the operating position at least one drive roller is mounted in the fastening element. The fastening element may be folded or rotated about an angle range of 0° to 180°, in particular 0° to 90°, in particular by means of one or a plurality of hinges. A rotating, folding, or hinged axis may be arranged in particular perpendicular to a drive roller axis. Moreover, the fastening element may advantageously be embodied to be movable translationally, in particular parallel, to the drive rollers by means of one or a plurality of rails, which may simplify the mounting, assembly, and disassembly of the at least one drive roller in the fastening element. It is also possible for the fastening element to be embodied movable parallel to the folding axis in order to simplify assembly. The one or plurality of hinges may also have clearance with respect to the fastening element, for example 3 mm or 7 mm or 10 mm of clearance. The cantilevered drive rollers may in particular each be mounted in the fastening element via their free ends. Furthermore, the fastening element may have a securing device for fixing the fastening element in a desired position and also for avoiding undesired upward and downward folding. In addition, a tension spring or compression spring may be used. Furthermore, the fastening element may comprise a serrated segment that has a plurality of teeth, wherein the teeth preferably extend, at least largely, to the frame. The at least one drive roller may preferably be mounted in one of the teeth. One tooth may be assigned to each drive roller. One tooth recess may advantageously act as mounting point for each respective drive roller in the teeth. Each tooth recess may be embodied in a circular or polygonal manner. Due to the mounting of the drive rollers in the fastening element, in particular in the teeth, it is possible to prevent or at least reduce sagging of the drive rollers. Furthermore, the serrated embodiment segment having the teeth may save material. The fastening element 6.1 may be in one piece or a plurality of pieces and in particular may have a plate screwed to the belt body, wherein the serrated segment is embodied movable relative to the plate.

One preferred embodiment of the invention provides that the frame is embodied in a trough shape. A trough-shaped frame may collect food residues, liquid and solid waste, and dust. In addition, a trough-shaped frame may act as a protective device against accidents, because it may provide mechanical shielding against movable, in particular rotating, components. The frame may have openings, for example slit-like openings, on a bottom of the frame. The openings may provide a view into the interior for someone standing outside thereof and may furthermore ensure that liquid substances drain off and that materials, and therefore costs, are saved. Furthermore, plug-in axles may be arranged or fastened more securely in a trough-shaped frame.

One further preferred embodiment of the invention provides that the drive rollers each have a free end, wherein a bearing pin is embodied on each free end. The bearing pins may be used as functional elements, in particular for mounting the drive rollers. For this, each bearing pin may be supported by its own counterbearing. This may attain the advantage that the drive rollers are mounted on both sides and the load is distributed more uniformly. The bearing pins may have a cylindrical, for example circular cylindrical, or polygonal cross-section. They may be arranged coaxially with the associated drive roller or excentrically thereto. They may each be embodied integrally with a drive roller or they may each be connected to the drive roller, for example by insertion or screwing in. Furthermore, the bearing pins may have an axial length that is preferably greater than 2 cm, particularly preferably greater than 3 cm. In addition, the bearing pins may be movable, in particular rotatable, with respect to the drive rollers. It is also possible for the bearing pins to have an external thread onto which elements having an internal thread and different external contours may be screwed.

According to one preferred embodiment of the invention, it is provided that recesses for mounting the drive rollers by means of their bearing pins are embodied in or on the frame. The bearing pins may be arranged in or on the recesses embodied on the frame. The bearing pins may preferably be fitted or inserted into the recesses. Alternatively, the frame may be moved such that the bearing pins are arranged in the recesses so that the recesses function as counter-bearings for the drive rollers. The recesses are preferably embodied in a wall of the frame that is embodied on an end face of the frame. The recesses may be configured as through-holes or as blind hole bores formed on an inner surface of the frame.

One advantageous embodiment of the invention provides that each bearing pin is embodied as an external hexagon and each recess is embodied as an internal hexagon. A good connection between the specific recesses and bearing pins may be produced using outer contours thereof that correspond to one another. A clearance fit between the recesses and bearing pins is possible in order to enable simple fitting or insertion into one another. For a particularly robust design and to ensure freedom from play and minimize vibration, a transition fit may also be formed between the recesses and bearing pins. The bearing pins are preferably each designed to rotate with respect to the drive roller. The advantage of this is that appropriate rotation of the bearing pins to the correct angular position facilitates insertion and therefore speeds up the removal and reinstallation of the frame. Alternatively, the recesses and bearing pins may also have an outer contour other than polygonal. The advantage of a polygon is, firstly, the optimized connection between the recess and the bearing pin due to a positive fit. Secondly, a polygonal bearing pin may be positioned flat in the recess and therefore cause less stress in the bearing point-in contrast to a point or linear bearing with correspondingly higher mechanical stress.

In one advantageous embodiment of the invention, it is provided that in the operating position at least one drive roller is mounted in the frame.

One preferred embodiment of the invention provides that the frame is embodied such that it can be removed from the apparatus and reconnected thereto. Due to the removability and reconnectability of the frame, cleaning of the frame is facilitated, since otherwise less easily accessible and inaccessible segments of the frame may be exposed and made accessible for cleaning.

According to one advantageous embodiment of the invention, it is provided that the apparatus comprises a carrier device for receiving the frame. The carrier device may be embodied in at least two parts and include the frame, wherein the frame may be arranged in or on the carrier device. A movable connection may be embodied between the frame and the carrier device. Guides or the like may be embodied on the carrier device and/or on the frame for preventing the frame from disconnecting from the carrier device. In addition, the carrier device may have laterally arranged elements and/or raised portions embodied integrally with the carrier device that also function as protection against material falling out or railings.

One preferred embodiment of the invention provides that the frame is translationally displaceable along the carrier device. The carrier device may have two rail-like segments along which the frame is translationally displaceable. The frame may have grooves or depressions corresponding to the rail-like segments. An embodiment in which the frame is guided on rollers along depressions embodied in the carrier device is also possible. A handle may be provided on the frame for manual displacement.

In one advantageous embodiment of the invention it is provided that the frame has at least one pin on an outer surface of the frame for limiting position. The frame that may be displaced along the carrier device may be limited in its translational movability. In particular, the frame may be pushed back and forth between two limit positions. A pin embodied on an outer surface of the frame may be used for limiting movement at least in a first direction. The pin may be guided along a guide embodied in the carrier device. The guide may be embodied between two fork tines of a fork-like segment of the carrier device. Furthermore, a plurality of pins, in particular two pins, may be embodied on the frame. For limiting position in a second direction opposing the first direction, the free ends of the fork tines may be connected to one another so that a closed guide results, along which closed guide the one pin, or, in the case of a plurality of guides, the plurality of pins, are movably arranged. A movement limitation in the first and/or second direction may also be effected by means of limiting elements embodied on the carrier device. The limiting elements may be projections, for example, that project into the movement path of the frame and prevent the movability of the latter from the outside beyond a certain position.

One advantageous embodiment of the invention provides that the carrier device is connected to the apparatus in a hinge jointed manner. The carrier device, together with the frame, may be pivoted by means of a hinge. In particular, the frame may be moved from the operating position to the maintenance position and from the maintenance position back to the operating position. The pivoting may be carried out manually. The pivoting may also be undertaken electrically, for example by means of an electric motor and a worm gear. The hinge may preferably be arranged on a stationary wall of the apparatus.

One preferred embodiment of the invention provides that, for transitioning from the maintenance position to the operating position, the frame is first pivoted and then displaced parallel to the drive rollers. The frame may be displaced translationally and until all drive rollers are supported in the frame.

In one preferred embodiment of the invention, it is provided that a conveyance direction of the conveyor belts and an axial direction of the drive rollers are arranged perpendicular and skewed relative to one another. The advantage of a configuration in which the conveyance direction of the conveyor belts and the axial direction of the drive rollers are arranged perpendicular to one another is that this enables clean guidance of the conveyor belts about the drive rollers and consequently a more efficient drive.

According to one advantageous embodiment of the invention, it is provided that the drive rollers 7 each have a profiling or structuring, in particular in the form of teeth, over an entire length for mechanical interaction with the conveyor belts 5, in particular for power transmission. Because the drive rollers have a structuring over their entire length, the advantage results that the belt body may be flexibly equipped with a variable number of conveyor belts. At least two of the conveyor belts may each have a different width. The overall advantage is that the belt body may be changed over for specific production requirements and equipped with two, three, four, five or six conveyor belts.

Further details, features, and advantages of the invention result from the drawings, as well as from the following description of a preferred embodiment, using the drawings. The drawings merely illustrate an exemplary embodiment of the invention and do not limit the essential idea of the invention.

### BRIEF DESCRIPTION OF THE DRAWINGS

FIG. 1 depicts a first perspective elevation of an inventive apparatus according to an exemplary embodiment.

FIG. 2 depicts the apparatus from FIG. 1 in a first perspective detail elevation.

FIG. 3 depicts the apparatus from FIG. 1 in a second perspective detail elevation.

FIG. 4 depicts the apparatus from FIG. 1 in a third perspective detail elevation.

FIG. 5 depicts the apparatus from FIG. 1 in a fourth perspective detail elevation.

FIG. 6 depicts the apparatus from FIG. 1 in a second perspective elevation.

FIG. 7 depicts a first perspective elevation of an inventive apparatus according to a further embodiment.

FIG. 8 depicts the further embodiment from FIG. 7 in a second perspective elevation.

FIG. 9 depicts a first perspective detail elevation of the further embodiment from FIG. 7.

FIG. 10 depicts a second perspective elevation of the further embodiment from FIG. 7.

### DETAILED DESCRIPTION

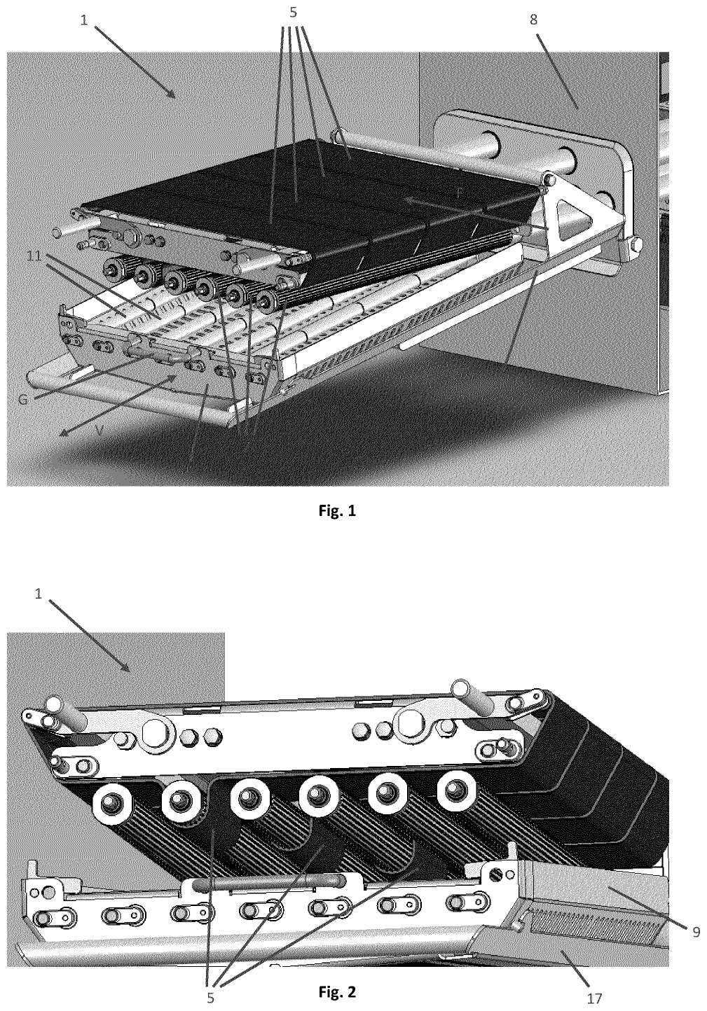

FIG. 1 depicts an inventive apparatus 1 for transporting food slices according to an exemplary embodiment. In the illustrated embodiment, the apparatus 1 has four conveyor belts 5 that are arranged parallel to one another and may transport food slices in a conveyance direction F. It is possible to design the apparatus 1 differently such that it comprises up to six conveyor belts 5. Furthermore, the apparatus 1 comprises six drive rollers 7 that are likewise arranged parallel to one another. The drive rollers 7 are embodied cantilevered and project through an apparatus wall 8 and out of the apparatus 1. The conveyance direction F and the drive rollers 7 are arranged perpendicular to one another. In addition, each of the four conveyor belts 5 is guided about exactly one of the drive rollers 7 and driven by the assigned rotating drive roller 7. In other words, two of the six drive rollers 7 in the illustrated embodiment are not driven, so that the apparatus 1 may be operated in a more energy efficient manner.

The apparatus 1 furthermore has a trough-shaped frame 9 that comprises seven plug-in axles 11 that are made of plastic, wherein in the depicted first perspective elevation in FIG. 1 only six of the seven plug-in axles 11 are visible. The plug-in axles 11 are securely connected to the frame 9. In addition, the frame 9 has a plurality of openings in its lateral walls, saving materials and costs.

Moreover, the apparatus 1 has a carrier device 17. The carrier device 17 is connected to the apparatus wall 8 in a hinge jointed manner. The frame 9 is arranged on the carrier device 17 and may be moved translationally along a displacement axis V.

The carrier device 17 together with the frame 9 may be pivoted between an operating position and a maintenance position, wherein the frame 9 in FIG. 1 is depicted in a maintenance position. In the maintenance position, an angle is formed between the drive rollers 7 and the plug-in axles 11. The frame may be removed and reinstalled manually in the maintenance position, for example for cleaning. A handle G is embodied on the frame 9 to facilitate removal and reinstallation.

Proceeding from the maintenance position, the pivotable carrier device 17 together with the frame 9 may be moved, folded, or pivoted into the operating position upward pressure. In the operating position (not shown), the plug-in axles 11 and the drive rollers 7 are arranged parallel to one another. In addition, in the operating position a drive roller 7 is arranged between every two plug-in axles 11. The plug-in axles 11 may guide the conveyor belt 5 assigned thereto and exert pressure thereon. The conveyor belt 5 may be tensioned, at least in part, using the pressure.

Furthermore, in the operating position the rotating drive rollers 7 are shielded from bystanders by the trough-shaped geometry of the frame 9 so that the frame 9 also contributes to occupational safety. The openings embodied in the wall of the frame 9 also ensure it is possible to look into the interior of the frame 9, in particular to see the drive rollers 7.

FIG. 2 depicts the apparatus 1 from FIG. 1 in a perspective detail elevation. Each of the four conveyor belts 5 is guided about exactly one drive roller 7, wherein the wrapping of one of the drive rollers 7 using one of the four conveyor belts 5 is not visible. Each of the four conveyor belts 5 wraps around a drive roller 7 assigned thereto at a wrap angle of essentially 180°. The precise arrangement or positioning of the conveyor belts 5 is indicated schematically. For example, on the conveyor belt 5 that is guided about the second drive roller 7 from the left in FIG. 2, horizontally arranged segments immediately to the right and left above the drive roller 7 appear to be pressed upwards. This effect, which is actually caused by the plug-in axles 11, is to be understood by interpretation. In other words, the conveyor belts 5 are shown in the operating position in FIG. 2, while the frame 9 and the carrier device 17 are illustrated in the maintenance position.

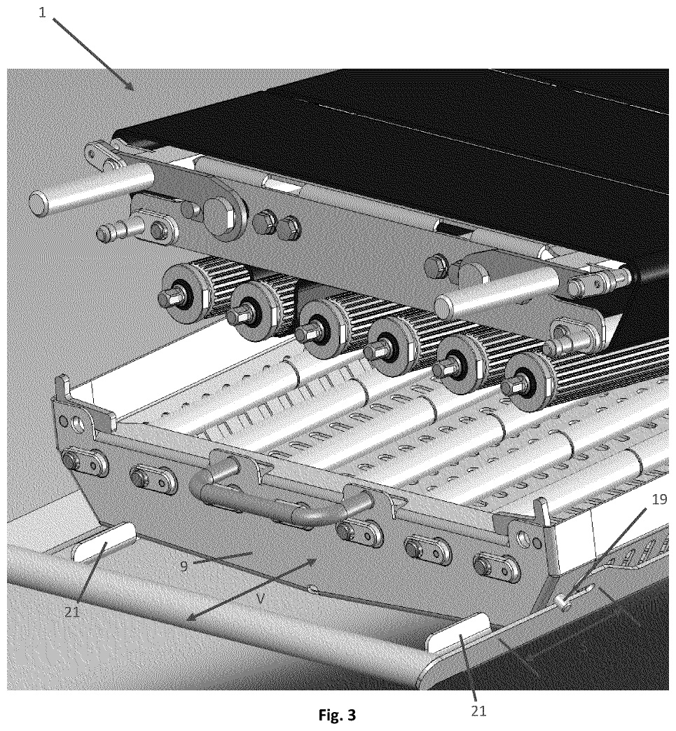

FIG. 3 depicts the apparatus 1 from FIG. 1 in a second perspective detail elevation. The frame 9, which is translationally movable along the displacement axis V, may be displaced between two limit positions. In other words, the frame 9 has a maximum displacement path S. Two pins 19, each embodied on an outer surface of the frame 9, limit the position in a first direction. One of the two pins 19 is not visible in FIG. 3. The frame 9 is limited in its translational movability in a second direction opposing the first direction using a pair of limiting elements 21 embodied on the carrier device 17. The limiting elements 21 are embodied integrally with the carrier device 17 and project into the movement path of the frame 9 and prevent the frame 9 from being displaced further along the displacement axis V in the second direction.

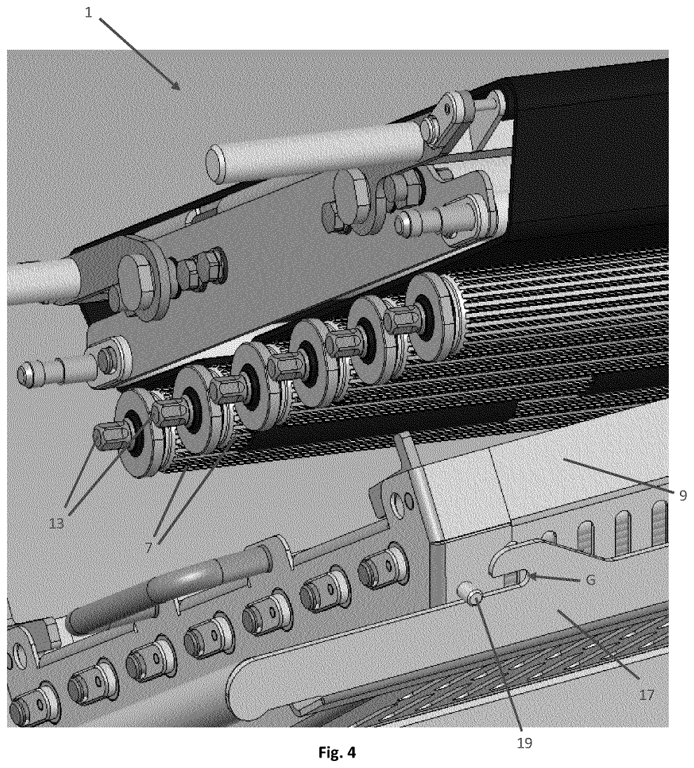

FIG. 4 depicts the apparatus 1 from FIG. 1 in a third perspective detail elevation. One segment of the carrier device 17 is embodied in a fork or U shape. A straight guide is embodied between two fork tines of the fork-shaped segment or between two legs of the U-shaped segment. The pin 19, and with the pin 19 also the frame 9, may be moved translationally along this guide. The frame 9, which is displaced to the right in FIG. 4, is prevented from further translational movement at a limit position G.

Furthermore, FIG. 4 depicts that one bearing pin 13 is arranged on each end face of every drive roller 7. The bearing pins 13 are each embodied as an external hexagon and extend primarily perpendicular to an assigned end face of each drive roller 7. The bearing pins 13 may be used to support the drive rollers 7 in that each interacts with a support surface, and this is described in the following.

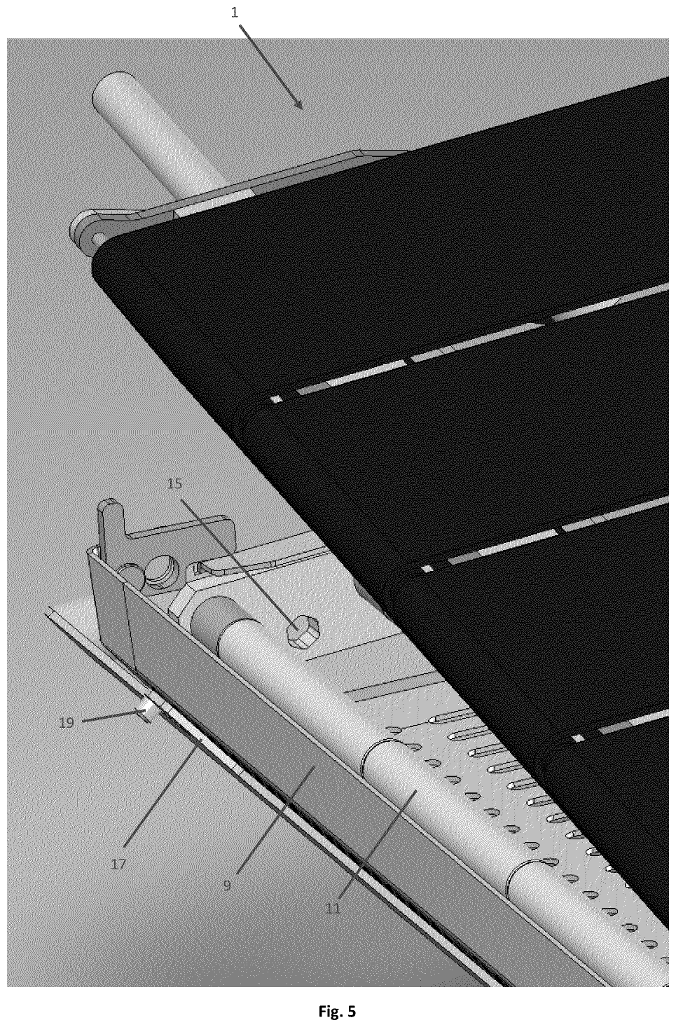

The apparatus 1 from FIG. 1 is depicted in a fourth perspective detail elevation in FIG. 5. For each bearing pin 13, a corresponding recess 15 is embodied in the frame 9, wherein in FIG. 5 only one of the six recesses 15 is visible. The recesses 15 are embodied as internal hexagons that fit the bearing pins 13. The bearing pins 13 may be fitted or inserted into the recesses 15. In the embodiment of the invention depicted, the frame 9 may be pivoted out of the maintenance position into the operating position and then moved translationally such that the recesses 15 are fitted over the location-fast bearing pins 13. There is a clearance fit between the recesses 15 and the bearing pins 13 for simple and low-friction displacement. However, it is also possible for there to be a transition fit. Furthermore, in FIG. 5 the seventh of the seven plug-in axles 11, which is not visible in the other figures, is easily seen.

In the operating position, the plug-in axles 11 are arranged parallel to the drive rollers 7 and the plug-in axles 11 are at least partially pressed against a conveyor belt 5.

Due to the arrangement of the bearing pins 13 in the recesses 15, in addition the drive rollers 7 are mounted on both sides. In other words, in the operating position the drive rollers 7 are no longer cantilevered. The load on the drive rollers may be distributed more uniformly using the mounting on two sides.

The pin 19, also visible in FIG. 5, may also be used for fixing the frame 9 and the carrier device 17 in the operating position. In other words, proceeding from the maintenance position, the carrier device 17 with the frame 9 may be pivoted upwards and folding down may be prevented by pushing the pin 19 into the fork-shaped or U-shaped segment of the carrier device 17.

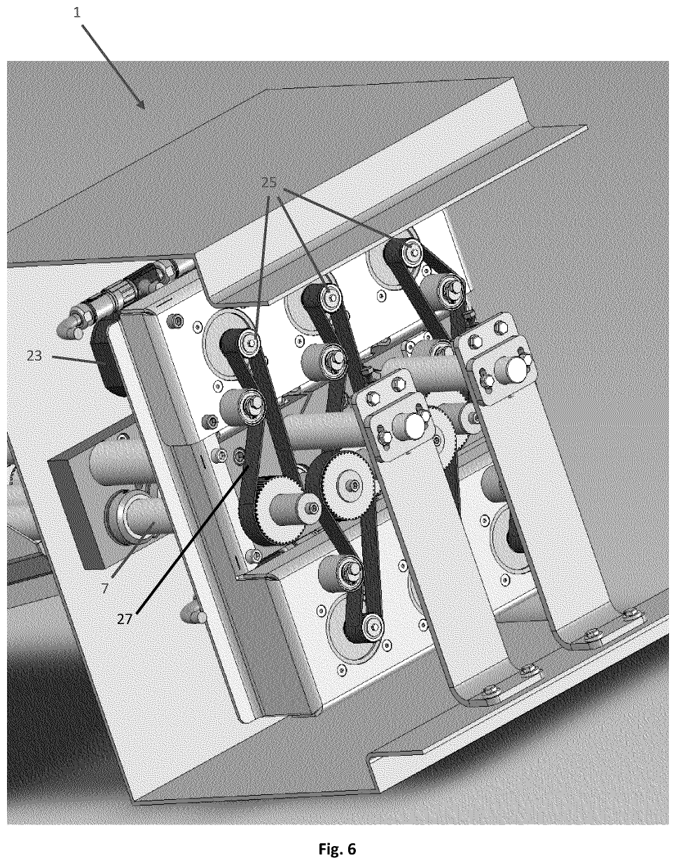

FIG. 6 depicts the apparatus 1 from FIG. 1 in a second perspective elevation. FIG. 6 provides a view of a back side of the apparatus 1. Allocated to each of the six drive rollers 7 is a drive that comprises an electric motor 23 having a pinion 25. In FIG. 6, only one of the six electric motors 23 is visible, at least in part. Each drive also comprises a gear stage, wherein the drive energy is transmitted to the drive rollers 7 via a transmission element 27 in the form of a toothed belt.

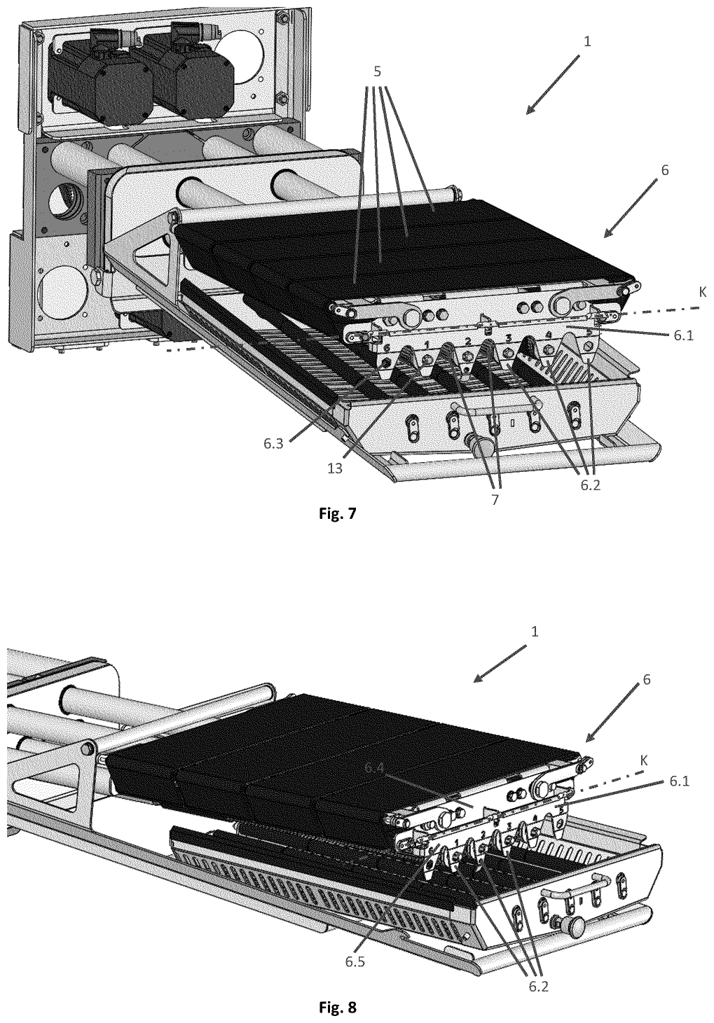

FIG. 7 depicts a first perspective elevation of an inventive apparatus 1 according to a further embodiment. A belt body 6, which also comprises four conveyor belts 5, has a hinged fastening element 6.1. The fastening element 6.1 has six teeth 6.2 and is folded down about a fold axis K. The fastening element 6.1 may be moved translationally by 20 mm (−10 mm to +10 mm) parallel to the fold axis in order to simplify the mounting and assembly of the drive rollers. In addition, the fastening element 6.1 may be moved in a direction perpendicular to the fold axis K, in particular parallel to the drive rollers 7, in particular by means of two rails, in order to further simplify the mounting of the drive rollers 7.

Furthermore, the apparatus 1 has four drive rollers 7 that are mounted in the fastening element 6.1 or each in one tooth 6.2. The drive rollers 7 each have a free end. A bearing pin 13 embodied as an external hexagon is embodied on each free end. The drive rollers 7 are each mounted in a tooth recess 6.3 by means of their bearing pins 13.

FIG. 8 depicts a second perspective elevation of the further embodiment from FIG. 7. The fastening element 6.1 has a plate 6.4 that is securely connected to the belt body 6. A serrated segment 6.5 that comprises the teeth 6.2 may be moved relative to the plate 6.4, in particular about the fold axis K.

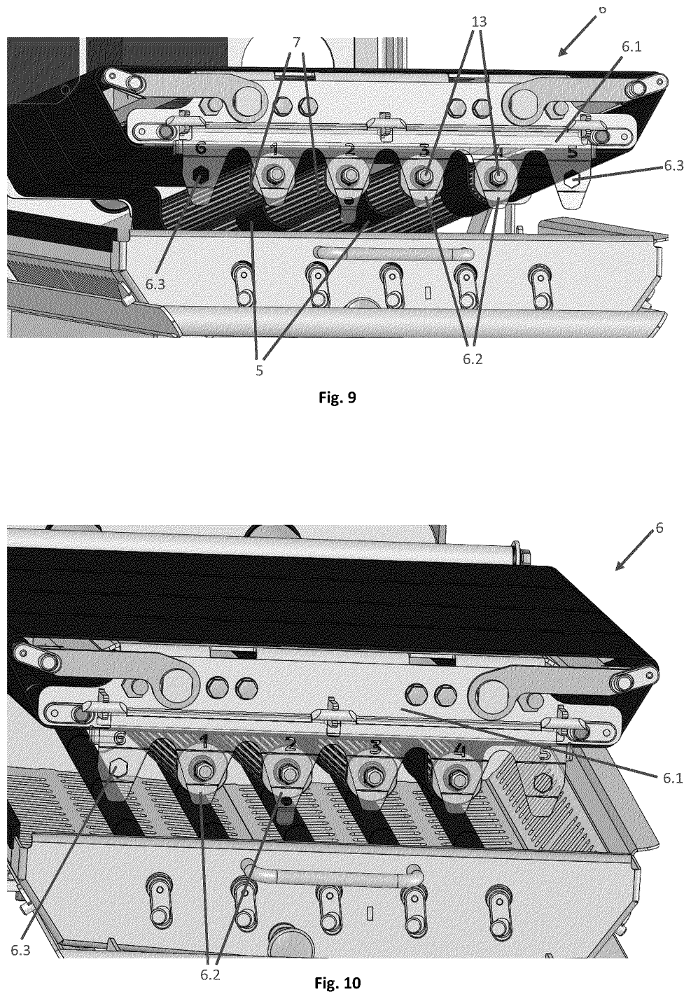

FIG. 9 depicts a first perspective detail elevation of the further embodiment from FIG. 7. The four conveyor belts 5 are wrapped around one drive roller 7 each and are driven by one drive roller 7 each. On their surface and across an entire length the drive rollers have a structuring. The conveyor belts are embodied like V-belts on one side and are mechanically linked to one drive roller 7 each. The drive rollers 7 are mounted on the fastening element 6.1 or in a tooth recess 6.3 of the teeth 6.2 via bearing pins 13. FIG. 10 depicts a second perspective detail elevation of the further embodiment from FIG. 7.

### REFERENCE NUMBERS

1 Apparatus
5 Conveyor belt
6 Belt body
6.1 Fastening element
6.2 Tooth
6.3 Tooth recess
6.4 Plate
6.5 Serrated segment
7 Drive rollers
8 Apparatus wall
9 Frame
11 Plug-in axle
13 Bearing pin
15 Recess
17 Carrier device
19 Pin
21 Limiting element
23 Electric motor
25 Pinion
27 Transmission element
F Conveyance direction
V Displacement axis
K Folding/hinged axis
S Maximum displacement path
G Limit position

1. An apparatus for transporting food slices comprising:
at least two conveyor belts,
at least two drive rollers, wherein each of the at least two conveyor belts can be guided about a respective one of the at least two drive rollers and can be driven thereby,
a moveable frame comprising a plurality of plug-in axles, each of the plurality of plug-in axles being securely connected to the moveable frame, wherein the moveable frame is moveable between an operating position and a maintenance position, wherein in the operating position, the at least two drive rollers and the plurality of plug-in axles are arranged parallel to one another, and each of the at least two drive rollers are arranged laterally between two plug-in axles.

2. The apparatus according to claim 1, wherein the moveable frame is pivotable between the operating position and the maintenance position, wherein in the maintenance position, an angle is formed between the at least two drive rollers and the plurality of plug-in axles.

3. The apparatus according to claim 1, wherein a belt body comprising the at least two conveyor belts has a foldable fastening element, wherein in the operating position at least one of the at least two drive rollers is mounted in the fastening element.

4. The apparatus according to claim 1, wherein the moveable frame is embodied in a trough shape.

5. The apparatus according to claim 1, wherein each of the at least two drive rollers have a free end, wherein a bearing pin is embodied on each free end.

6. The apparatus according to claim 5, wherein recesses for mounting the drive rollers by means of their bearing pins are embodied in or on the moveable frame.

7. The according to claim 6, wherein each bearing pin is embodied as an external hexagon and each recess is embodied as an internal hexagon.

8. The apparatus claim 1, wherein in the operating position, at least one drive roller is mounted in the moveable frame.

9. The apparatus according to claim 1, wherein the moveable frame is removable from the apparatus and can be reconnected thereto.

10. The apparatus according to claim 1, wherein the apparatus comprises a carrier device for receiving the moveable frame.

11. The apparatus according to claim 10, wherein the moveable frame is translationally moveable along the carrier device.

12. The apparatus according to claim 10, wherein the moveable frame has at least one pin embodied on an outer surface of the moveable frame for limiting position.

13. The apparatus, according to claim 10, wherein the carrier device is connected to the apparatus in a hinge jointed manner.

14. The apparatus according to claim 1, wherein the apparatus is configured such that, for transitioning from the maintenance position to the operating position, the frame is first pivoted and then displaced parallel to the drive rollers.

15. The apparatus according to claim 1, wherein a conveyance direction of the conveyor belts and an axial direction of the drive rollers are arranged perpendicular and skewed relative to one another.

16. The apparatus according to claim 1, wherein the drive rollers each have a profiling or structure in the form of teeth; over an entire length for mechanical interaction with the conveyor belts for power transmission.
